(19) United States
(12) Patent Application Publication
(10) Pub. No.: US 2024/0290207 A1
(43) Pub. Date: Aug. 29, 2024

(54) WRONG WAY DRIVING DETECTION AND AMELIORATION

(71) Applicant: INTERNATIONAL BUSINESS MACHINES CORPORATION, Armonk, NY (US)

(72) Inventors: Michael S. Gordon, Croton on Hudson, NY (US); Kevin W. Brew, Niskayuna, NY (US); Mattias Fitzpatrick, Mount Kisco, NY (US); Matthew Beck, Danbury, CT (US); Brian Paul Gaucher, Brookfield, CT (US)

(21) Appl. No.: 18/175,570

(22) Filed: Feb. 28, 2023

(51) Int. Cl. G08G 1/16; B60W 50/14; B60W 60/00; G06V 20/56; G06V 20/58; G08G 1/056

(52) U.S. Cl. CPC G08G 1/164; B60W 50/14; B60W 60/0059; G06V 20/582; G06V 20/588; G08G 1/056; B60W 2050/143; B60W 2050/146; B60W 2420/403; B60W 2520/06; B60W 2552/53; B60W 2556/50

(57) ABSTRACT

According to one embodiment, a method, computer system, and computer program product for wrong way driving detection is provided. The embodiment may include monitoring indications of wrong way traversal along a traversal path through one or more on-board, Internet of Things (IOT) sensors. The embodiment may also include determining whether wrong way traversal of the traversal path is occurring based on a risk assessment value satisfying a preconfigured threshold. The embodiment may further include, in response to determining the risk assessment value satisfies the preconfigured threshold, performing a corrective action to ameliorate the wrong way traversal.

### BACKGROUND

The present invention relates generally to the field of computing, and more particularly to traffic control system.

Traffic control systems are a technological solution that strives to efficiently move vehicles through municipalities via various traversal media, such as roadways, railways, and waterways. Through the utilization of a distributed network of sensors and infrastructure elements, traffic control systems can execute various tasks, such as automatic redirection of traffic to reduce congestion. As such, traffic control systems are an example of the Internet of Things (IOT).

IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

### SUMMARY

According to one embodiment, a method, computer system, and computer program product for wrong way driving detection is provided. The embodiment may include monitoring indications of wrong way traversal along a traversal path through one or more on-board, Internet of Things (IOT) sensors. The embodiment may also include determining whether wrong way traversal of the traversal path is occurring based on a risk assessment value satisfying a preconfigured threshold. The embodiment may further include, in response to determining the risk assessment value satisfies the preconfigured threshold, performing a corrective action to ameliorate the wrong way traversal.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a wrong way driving detection process according to at least one embodiment.

FIGS. 3A and 3B illustrate an operational flowchart for a wrong way driving decision process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to traffic control systems. The following described exemplary embodiments provide a system, method, and program product to, among other things, detect wrong way traffic entities and perform ameliorative actions to avoid catastrophic scenarios. Therefore, the present embodiment has the capacity to improve the technical field of traffic control systems by utilizing IoT devices to effectively warn and reduce, or eliminate, dangers caused by a wrong way driver.

As previously described, traffic control systems are a technological solution that strives to efficiently move vehicles through municipalities via various traversal media, such as roadways, railways, and waterways. Through the utilization of a distributed network of sensors and infrastructure elements, traffic control systems can execute various tasks, such as automatic redirection of traffic to reduce congestion. As such, traffic control systems are an example of the Internet of Things (IOT).

IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

Vehicles that traverse roadways opposite to the traditional flow of traffic can cause devastating accidents on roadways around the world. There are many different causes for an individual to traverse a roadway against the flow of traffic such as, but not limited to, distracted driving, inebriation, and emergency situations. Many times, if a wrong way driver is not alerted quickly, collisions with other vehicles and or obstacles (e.g., trees, signs, and infrastructure elements) may result in the death of the wrong way driver and/or other motorists, passengers, and/or bystanders.

Traffic planners, such as civil engineers and city planners, attempt to reduce wrong way drivers and resultant wrong way accidents through strategic placement of signage at locations predicted to have a high likelihood of resulting in drivers entering a roadway in the opposite direction to the flow of traffic. Common examples include the placement of “Do Not Enter”, “Wrong way”, or other prohibitive entry signs facing in the opposite direction to the flow of traffic on interstate off ramps.

Additionally, some technologies have been developed that utilize radar detection to identify vehicles driving in the wrong direction on a roadway. This initial detection triggers flashing lights to alert the offending drivers then transmits a notification to authorities as well as real-time messaging systems along the roadway to alert other motorists of the wrong way driver. However, roadway signage and current wrong way driver technologies are generally limited to the initial wrong way entry and does not exist on routes extensively, which might result in a wrong way driver missing the initial indications of their incorrect roadway traversal. As such, it may be advantageous to, among other things, implement on-board sensors to identify when a vehicle is proceeding along a roadway in a direction opposite to the standard flow of traffic and perform an ameliorative action for cease the wrong way driving.

According to one embodiment, a wrong way driving detection program may utilize on-board vehicle sensors, such as a dashboard-mounted, forward-facing camera, to capture environmental data surrounding the vehicle. The wrong way driving detection program may then analyze the captured environmental data to identify indications that the vehicle is proceeding in a direction that is against the designated direction of traffic for a particular roadway. If the wrong way driving detection program determines that the vehicle is indeed travelling in the opposite direction of the roadway's designated traffic pattern, then the wrong way driving detection program may execute an ameliorative action, such as turning the vehicle to the roadway shoulder and decelerating the vehicle or displaying one or more notification messages to the driver of the vehicle and other vehicle drivers within a preconfigured distance.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

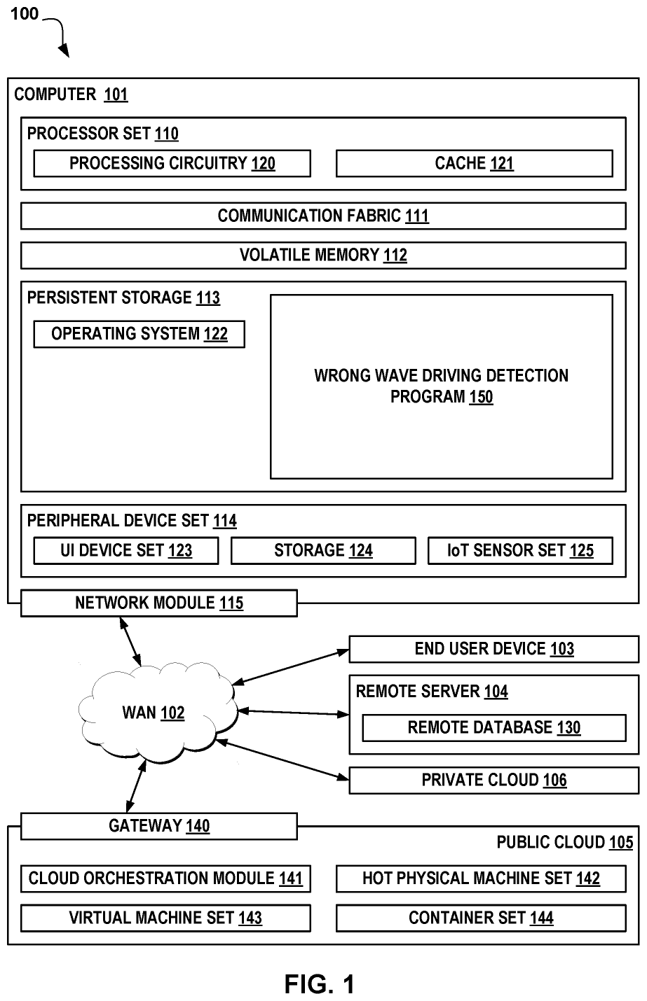

Referring now to FIG. 1, computing environment 100 contains an example of an environment for the execution of at least some of the computer code involved in performing the inventive methods, such as wrong way driving detection program 150. In addition to wrong way driving detection program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and wrong way driving detection program 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in wrong way driving detection program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in wrong way driving detection program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

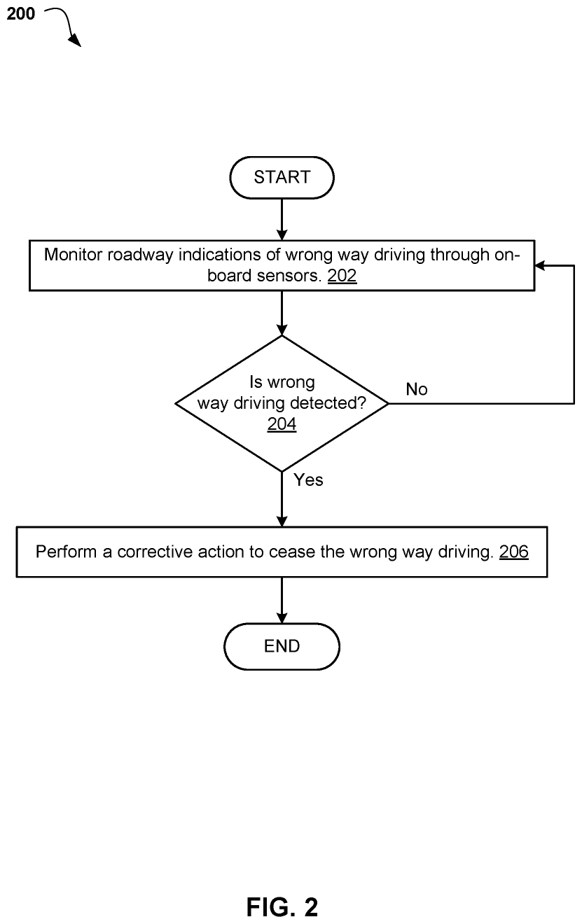

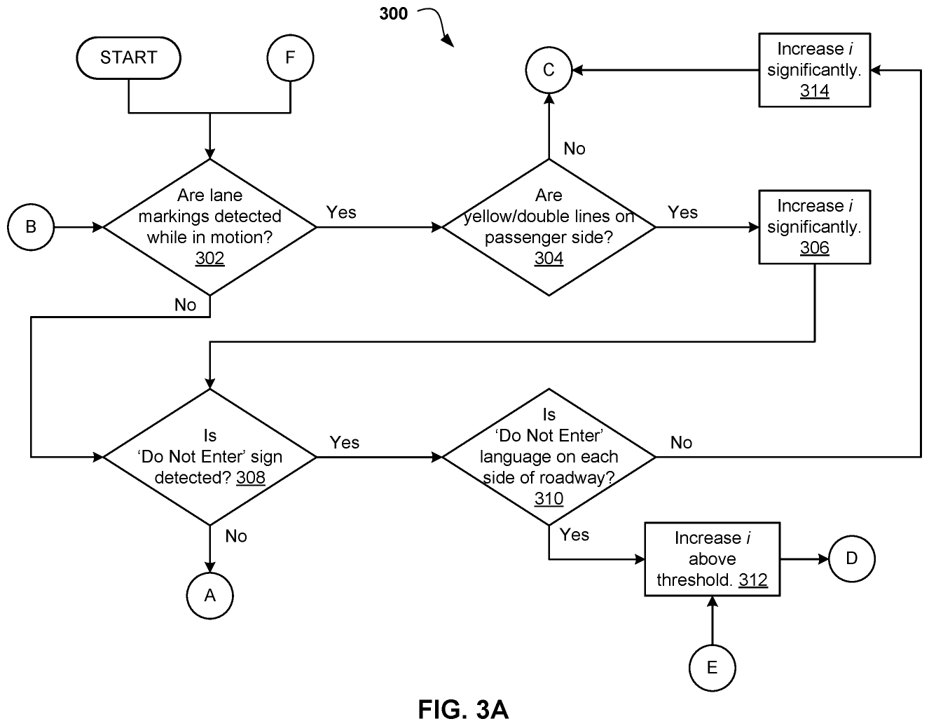

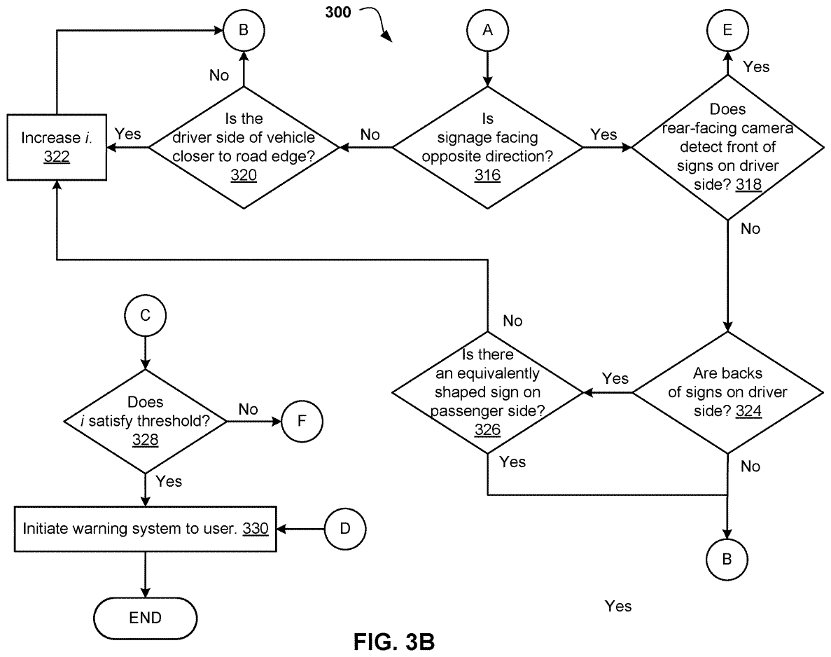

According to at least one embodiment, the wrong way driving detection program 150 may gather environmental information surrounding a vehicle travelling on a roadway that, through analysis, may reduce the likelihood of a driver travelling the wrong direction on a roadway. To gather the environmental information, the wrong way driving detection program 150 may utilize a series of sensors, such as IoT sensor set 125, and software technologies, such as image recognition and artificial intelligence. The sensors may capture images of various roadway elements and characteristics, such as roadway signage roadway markings, to identify if the presence of those elements and characteristics are consistent with proper driving direction for the locality in which the vehicle is present. If the wrong way driving detection program 150 determines a vehicle is traversing a roadway inconsistently to the standard traffic laws of the locality in which it is present, the wrong way driving detection program 150 may perform one of a variety of remedial actions to reduce, or eliminate, the dangers presented by the wrong direction road traversal. In at least one embodiment, the wrong way driving detection program 150 may utilize an initial positive detection of wrong way driving by a user to initiate a stricter detection in future usage interactions. For example, if the wrong way driving detection program 150 detects wrong way driving by a user once, the wrong way driving detection program 150 may lower the threshold value needed to trigger remedial actions in future situations for that user. Furthermore, notwithstanding depiction in computer 101, the wrong way driving detection program 150 may be stored in and/or executed by, individually or in any combination, end user device 103, remote server 104, public cloud 105, and private cloud 106. The wrong way driving detection method is explained in more detail below with respect to FIGS. 2, 3A, and 3B.

Referring now to FIG. 2, an operational flowchart for a wrong way driving detection process 200 is depicted, according to at least one embodiment. At 202, the wrong way driving detection program 150 monitors roadway indications of wrong way driving through on-board sensors. The wrong way driving detection program 150 may utilize a variety of roadway indicators of wrong direction driving, such as, but not limited to, roadway signage indicative of the vehicle's current course being in the wrong direction to the flow of traffic and painted roadway indicators detected incorrectly on the roadway.

Worldwide, there are numerous shapes, styles, and sizes of roadway signage. However, many roadway signs are typically only painted on the side intended for viewing by motorists and pedestrians while traversing a roadway, walkway, waterway, or any other traversal path. For example, a stop sign in the United States is represented as a red octagon with the word “STOP” written in white lettering on the traffic-facing side but, typically, is left as unpainted metal on the reverse side. Similarly, the presence of reflective, painted traffic indicators on roadways varies from country to country but is typically present on most heavily trafficked roadways. For example, many bi-directional roadways in the United States utilize a double yellow line to separate traffic lanes for vehicles proceeding in opposite directions and a single white line to indicate the end of the traffic lane or roadway and the start of the road shoulder.

The wrong way driving detection program 150 may utilize various on-board sensors to gather environmental data regarding the presence or absence of typical indicators of correct roadway traversal direction. The on-board sensors may include, but are not limited to, forward-facing cameras (e.g., a dashboard-mounted and fender-mounted), rear-facing cameras (e.g., mounted above or near a vehicle license plate or rear fender-mounted), side facing cameras (e.g., door pillar-mounted cameras), ultrasonic sensors, radar sensors, LiDAR sensors, global positioning system (GPS) sensors, and any other sensor that may be included in IoT sensor set 125. The on-board sensors may be positioned such that there is a limited field of view to allow for detection of features of interest relative to the driver's position.

Next, at 204, the wrong way driving detection program 150 determines whether wrong way driving is detected. The wrong way driving detection program 150 may analyze the various feeds of gathered environmental data for indications that the driver of the vehicle from which the environmental data was gathered is traversing the roadway in the wrong direction to the flow of traffic. The wrong way driving detection program 150 may calculate a numerical value correlated to the likelihood that a driver is travelling in the wrong direction on a given throughfare. The wrong way driving detection program 150 may utilize the analysis of the various feeds of gathered environmental data to calculate the numerical value. The analysis and calculation of the numerical value, or risk assessment, is discussed further in FIGS. 3A and 3B in the wrong way driving decision process 300.

In at least one embodiment, the wrong way driving detection program 150 may utilize sign shape when determining the importance of correcting the wrong way driving. For example, a forward-facing camera may detect not only the lack of words on a sign for which words should be present (e.g., a stop sign), indicating that the driver is headed in the wrong direction to other vehicles on the roadway, but also the type of sign by the shape of the sign.

In another embodiment, the wrong way driving detection program 150 may utilize image recognition to correlate data between a forward-facing camera and a rear-facing camera such that, if the forward-facing camera detects a lack of words/colors on a multitude of signs while the rear-facing camera detects both words and colors, the risk assessment calculated by the wrong way driving detection program 150 indicating that the vehicle is going in the wrong direction may be raised by a preconfigured level. Depending on the indicator identified during the analysis, the wrong way driving detection program 150 may increase, decrease, or increment the numerical value of the risk assessment by one or more units. Once the numerical value reaches a preconfigured threshold, the wrong way driving detection program 150 may determine the user is driving in the wrong direction on a thoroughfare and initiate a remedial or corrective action to either reduce or eliminate any dangers caused by the driver's wrong way traversal. For example, on a split highway in the United States, should a forward-facing camera detect a backwards facing roadway sign on the left most part of its image immediately followed by the rear-facing camera detecting a forward-facing sign on the right-most part of its image, the wrong way driving detection program 150 may correlate these two data points together as a wrong way driving detection event that immediately increases the numerical value above the preconfigured threshold, which may trigger a remedial action described further in step 206.

Then, at 206, the wrong way driving detection program 150 performs a corrective action to cease the wrong way driving. Once the wrong way driving detection program 150 determines a driver is traversing a thoroughfare in the wrong direction, the wrong way driving detection program 150 may perform one or more remedial, or corrective, actions that are aimed to reduce or eliminate any danger resulting from the wrong way traversal. The remedial or corrective actions may include, but are not limited to, a notification displayed on a heads-up display of the vehicle, an audio notification played to the user through a speaker, displaying a notice on one or more other vehicle heads-up displays within a preconfigured distance, transmitting a notification to one or more authorities capable of issuing an emergency response, and transmitting a notification to one or more annunciator signs along the travel path of the wrong way driving vehicle.

In at least one embodiment, the wrong way driving detection program 150 may present alerts to the driver of the wrong way driving vehicle in varying degrees of intensity. For example, if the driver is proceeding the wrong way on a highway exit ramp, the wrong way driving detection program 150 may brightly display a warning notification on a vehicle heads-up display in large bright lettering with one or more icons. Similarly, the wrong way driving detection program 150 may increase the intensity of the warning notification should the vehicle continue traveling on the thoroughfare in the wrong direction. For example, if the wrong way driving detection program 150 determines the vehicle has not changed course or decelerated after five seconds of issuing a notification, the wrong way driving detection program 150 may display a larger and/or brighter visual notification and/or increase volume of an audio notification. In at least one other embodiment, should a driver not respond to warning messages for a preconfigured period of time, the wrong way driving detection program 150 may transmit an alert notification to one or more authorities nearest to the vehicle's current position as determined by GPS. For example, if the wrong way driving detection program 150 determines the user has ignored or is otherwise not responding to the visual and/or audio notifications after 10 seconds, the wrong way driving detection program 150 may transmit a notification to local first responders (e.g., police, firefighters, EMTs, highway safety officials, etc.) in order for those authorities to respond in a prompt manner.

Referring now to FIG. 3A, an operational flowchart for a wrong way driving decision process 300 is depicted according to at least one embodiment. While determining whether a vehicle is traversing a roadway in a direction opposite of, or any other way not in parallel with, the intended flow of traffic, the wrong way driving detection program 150 may utilize a numerical value counter associated with a risk assessment as described in step 204. The wrong way driving detection program 150 may proceed through various decision steps that, depending on a decision in the affirmative or negative, may increment the numerical counter value i by one or more units. As previously described, if the numerical value i satisfies a preconfigured threshold value, the wrong way driving detection program 150 may initiate a corrective action intended to reduce or eliminate the danger imposed by the vehicle proceeding in a manner that is not with the intended flow of traffic.

In at least one embodiment, if the wrong way driving detection program 150 determines a decision step in the negative, which may indicate that the vehicle is travelling parallel to the intended flow of traffic, the wrong way driving detection program 150 may reset the numerical value i. For example, if the wrong way driving detection program 150 determines that double yellow lines on a roadway are detected correctly on the driver's side of a passenger vehicle, then the wrong way driving detection program 150 may determine the vehicle is properly driving parallel to the intended flow of traffic and the wrong way driving detection program 150 may reset the numerical value i to zero, or to some other, preconfigured default count.

At 302, the wrong way driving detection program 150 determines whether lane markings are detected while in motion. While a vehicle is in motion, the wrong way driving detection program 150 may utilize any of the on-board sensors (e.g., IoT sensor set 125) to determine whether lane markings are detected around the vehicle. For example, the wrong way driving detection program 150 may analyze an on-board camera feed, such as a front fender-mounted camera, to determine whether lane markings are present on the roadway. The wrong way driving detection program 150 may determine if lane markings are present through image analysis of the captured sensor feeds. For example, the wrong way driving detection program 150 may identify lane markings as being double yellow lines or single solid white lines on the roadway through analysis of the gathered sensor feed. In one or more embodiments, the wrong way driving detection program 150 may determine lane markings based on reflectiveness of the entities within the gathered sensor feed. For example, many lane markings are painted on roadways with reflective paint for better nighttime visibility.

If the wrong way driving detection program 150 determines lane markings are detected while in motion (step 302, “Yes” branch), then the wrong way driving decision process 300 may proceed to step 304 to determine whether yellow and/or double lines are located on the passenger side of the vehicle. If the wrong way driving detection program 150 determines no lane markings are detected while in motion (step 302, “No” branch), then the wrong way driving decision process 300 may continue to step 308 to determine whether a “Do Not Enter”, or other prohibitive entry, sign is detected.

Then, at 304, the wrong way driving detection program 150 determines whether yellow-colored or double lines are present on the passenger side of the vehicle. Once the wrong way driving detection program 150 determines whether lane markings have been detected, the wrong way driving detection program 150 may proceed to identify the type of lane markings present within the gathered sensor feed and where those identified lane markings are located around the vehicle. For example, in the United States, double yellow lines are typically painted on roadways and indicate the separation between lanes of antiparallel traffic flow. Therefore, double yellow lines are typically present on the driver side of vehicles. If located on a different side of the vehicle, the wrong way driving detection program 150 may determine i should be increased as that may indicate a driver is proceeding in a direction not in parallel with the intended flow of traffic for that roadway.

If the wrong way driving detection program 150 determines yellow and/or double lines are on the passenger side of the vehicle (step 304, “Yes” branch), then the wrong way driving decision process 300 may proceed to step 306 to significantly increase i. If the wrong way driving detection program 150 determines yellow and/or double lines are not on the passenger side of the vehicle (step 304, “No” branch), then the wrong way driving decision process 300 may continue to step 328 to determine whether the value of i satisfies the preconfigured threshold.

Next, at 306, the wrong way driving detection program 150 increases i significantly. If the wrong way driving detection program 150 determines the presence of lane markings being in positions inconsistent with how expected traversal of a roadway dictates, the wrong way driving detection program 150 may increase the numerical value of i. Depending on the specific location of such markings, the wrong way driving detection program 150 may identify their placement in the environment around the vehicle as a strong indication that the vehicle is not traveling in a parallel manner to the intended traffic pattern. For example, if the wrong way driving detection program 150 determines that double yellow lines painted on a roadway are on the passenger side of the vehicle, the wrong way driving detection program 150 may increase the numerical value of i by a significant value. Since the United States traffic laws dictate that traffic should travel on the right hand side of the roadway, the double yellow lines painted on the roadway should be located on the driver's side of a vehicle. As such, identification of double yellow lines on any other side of a vehicle's traffic pattern may trigger the incrementation of the numerical value i. In at least one embodiment, a significant value may be any preconfigured value above a standard unit of incrementation, including, but not limited to, two points of incrementation or doubling of the current numerical value i.

Then, at 308, the wrong way driving detection program 150 determines whether a “Do Not Enter” sign is detected. As described in step 202, the wrong way driving detection program 150 may utilize on-board sensors, such as a cameras, to capture the environmental surrounding of the vehicle. In one or more embodiments, the wrong way driving detection program 150 may analyze the gathered data to identify images of street signs and on-roadway markings surrounding the vehicle. The wrong way driving detection program 150 may determine various aspects of the street signs including, but not limited to, type of sign, sign color, lettering on the sign, and sign orientation. Furthermore, the wrong way driving detection program 150 may analyze various on-roadway markings and marking characteristics including, but not limited to, color, size, shape, and orientation. The wrong way driving detection program 150 may utilize image recognition, optical character recognition, and/or natural language processing to determine the lettering and words depicted on any particular sign or on-roadway marking. Certain lettering or words on a sign or on-roadway marking may be indicative of a driver proceeding in the wrong direction on a roadway. For example, if the wrong way driving detection program 150 determines a sign facing the vehicle as the vehicle proceeds down a roadway depicts the words “Do Not Enter”, this sign's placement by be indicative that the vehicle is proceeding in the wrong direction down a roadway. Although “Do Not Enter” signs are used in exemplary embodiments, the wrong way driving detection program 150 may be programed to recognize alternate iterations of prohibitive entry language or utilize semantic analysis to identify equivalent wordings on-the-fly. For example, signage may utilize “No Admittance” or “Stay Out” as being equivalent to “Do Not Enter”.

If the wrong way driving detection program 150 determines a “Do Not Enter” sign is detected (step 308, “Yes” branch), then the wrong way driving decision process 300 may proceed to step 310 to determine whether the “Do Not Enter” language is on each side of the roadway. If the wrong way driving detection program 150 determines a “Do Not Enter” sign is not detected (step 308, “No” branch), then the wrong way driving decision process 300 may continue to step 316 to determine whether signage is facing in an opposite direction.

Next, at 310, the wrong way driving detection program 150 determines whether a sign with “Do Not Enter” language is on both sides of the roadway. Many roadways with “Do Not Enter” signage to indicate that motorists should not proceed past the signage have signage located on both sides of the roadway. For example, on many interstate exit ramps in the United States, “Do Not Enter” signs on both the left-hand and right-hand sides of the exit ramp facing away from the flow of traffic to deter motorists from mistakenly entering the interstate through on offramp and proceeding onto the interstate heading in an antiparallel direction to the flow of traffic.

If the wrong way driving detection program 150 determines a sign with “Do Not Enter” language is on each side of the roadway (step 310, “Yes” branch), then the wrong way driving decision process 300 may proceed to step 312 to increase i above the preconfigured threshold. If the wrong way driving detection program 150 determines a sign with “Do Not Enter” language is not on each side of the roadway (step 310, “No” branch), then the wrong way driving decision process 300 may continue to step 314 to increase i significantly.

Then, at 312, the wrong way driving detection program 150 increases i above the threshold. As previously described in step 306, the wrong way driving detection program 150 may increment the numerical value i under certain circumstances that are likely a sign of a driver travelling against the flow of traffic. As some environmental elements may be more indicative of wrong way driving than others, the wrong way driving detection program 150 may automatically increase the numerical value i above the preconfigured threshold when a preconfigured event is identified. For example, in step 310, the wrong way driving detection program 150 may identify “Do Not Enter” signs are placed on both sides of a roadway as the user vehicle passes by. Since placement of these two signs is a clear indication of wrong way driving, the wrong way driving detection program 150 may immediately increase i above the preconfigured threshold so that when a check of the value i is performed, the wrong way driving detection program 150 will trigger a corrective action.

Next, at 314, the wrong way driving detection program 150 increases i significantly. Similar to step 306, the wrong way driving detection program 150 may increment i significantly when certain entities or events are detected around the vehicle but those events do not quite warrant the increase of i to the preconfigured value that would trigger a corrective action by the wrong way driving detection program 150. For example, if the wrong way driving detection program 150 identifies a “Do Not Enter” sign around the vehicle but only a single “Do Not Enter” sign is present on one side of the roadway, the wrong way driving detection program 150 may determine that sign's presence is a strong indication of wrong way driving but not strong enough, as the presence of two signs on opposing sides of the road would be, to trigger the incrementation of i to the preconfigured threshold since a single “Do Not Enter” sign may be intended for drivers traversing a nearby parallel roadway to the one being traversed.

Referring now to FIG. 3B, at 316, the wrong way driving detection program 150 determines whether signage is facing the opposite direction. Another indication that a vehicle is driving in the opposite direction to the flow of intended traffic may be the presence of wording on the backside of signage. For example, a user driving in the wrong direction on a roadway may pass a stop sign facing in the opposite direction. The wrong way driving detection program 150 may identify the reverse side of signage through image analysis technologies, such as image recognition of particular colors or sign shapes or natural language processing of lettering on the reverse side of signage. For example, the wrong way driving detection program 150 may identify road signs as unpainted on their reverse side as an unfinished aluminum surface identifiable, which may be silver in color, or through manufacturer lettering on the reverse side of the sign. As an additional example, the wrong way driving detection program 150 may identify a yield sign was passed by the presence of a silver equilateral triangle captured by a forward-facing on-board camera.

If the wrong way driving detection program 150 determines signage is facing the opposite direction (step 316, “Yes” branch), then the wrong way driving decision process 300 may proceed to step 318 to determine whether a rear-facing camera detects front faces of signs on the vehicle's driver side. If the wrong way driving detection program 150 determines signage is not facing the opposite direction (step 316, “No” branch), then the wrong way driving decision process 300 may continue to step 320 to determine whether the driver side of the vehicle is closer to the roadway edge than the passenger side of the vehicle.

Then, at 318, the wrong way driving detection program 150 determines whether a rear-facing camera detects forward facing signage on the driver side of the vehicle. As an additional assurance of wrong way driving when the wrong way driving detection program 150 has identified the reverse side of a sign passed by the vehicle by a forward-facing camera, the wrong way driving detection program 150 may utilize a rear-facing camera to confirm the orientation of the passed sign was away from the vehicle's traversal path along the roadway. For example, continuing the example above regarding the reverse side of a yield sign identified by the wrong way driving detection program 150 due to the sign's equilateral triangle shape and silver color, the wrong way driving detection program 150 may confirm the orientation of the sign by identifying the word “YIELD”, through image analysis, optical character recognition, and/or natural language processing, written on the sign as captured by a rear-facing camera.

Furthermore, the presence of the signage facing away from the vehicle's traversal path on the driver's side of the vehicle may be a further indication that the vehicle is traversing the roadway opposite to the intended traversal path. Typically, many roadway signs, in the United States, are located on the passenger side, or right side, of a roadway. As such, a rear-facing camera capturing the front face of a sign being on the driver side of the roadway may be another indication that the vehicle is travelling against the intended flow of traffic. For example, a rear-facing on-board camera should typically capture the reverse side of road signage. If the rear-facing on-board camera captures the front face of a sign, the wrong way driving detection program 150 may further determine that the vehicle is not travelling in the proper direction on the roadway.

If the wrong way driving detection program 150 determines a rear-facing camera detects front faces of signs on the vehicle's driver side (step 318, “Yes” branch), then the wrong way driving decision process 300 may return to step 312 to increase i above the preconfigured threshold. If the wrong way driving detection program 150 determines a rear-facing camera does not detect front facing signs on the driver side of the vehicle (step 318, “No” branch), then the wrong way driving decision process 300 may continue to step 324 to determine whether the backs of signs are on the driver side of the vehicle.

Next, at 320, the wrong way driving detection program 150 determines whether the driver side of the vehicle is closer to the road edge than the passenger side. Typically, traversal on roadways in countries where vehicle travel on the right-hand side of the road results in the passenger side, or the right side, of the vehicle being nearest to the edge of the roadway. Although, this may not be true in situations where the roadway is a single, one-direction lane of traffic, many other roadways with bidirectional or multi-lane traffic may follow this orientation. Therefore, if the wrong way driving detection program 150 determines, through image analysis of the gathered feed from on-board sensors, that the passenger side of the vehicle is not nearest to the edge of the roadway, the wrong way driving detection program 150 may take this determination as a further indication of wrong way driving. The wrong way driving detection program 150 may identify the vehicle's location on the roadway or nearness to the edge of the roadway by identifying color changes in the captured sensor feed. For example, the wrong way driving detection program 150 may determine that a color shift from black or gray to green, brown, or white may be a delineation between the edge of the roadway and grassy, wooded, or snowy terrain, respectively.

If the wrong way driving detection program 150 determines the driver side of the vehicle is closer to the roadway edge than the passenger side of the vehicle (step 320, “Yes” branch), then the wrong way driving decision process 300 may proceed to step 322 to increase i. If the wrong way driving detection program 150 determines the driver side of the vehicle is not closer to the roadway edge than the passenger side of the vehicle (step 320, “No” branch), then the wrong way driving decision process 300 may return to step 302 to determine whether lane markings are detected while the vehicle is in motion.

Then, at 322, the wrong way driving detection program 150 increases i. Similar to steps 306, 312, and 316, the wrong way driving detection program 150 may increment i when certain characteristics are present in the captured sensor feed. Although steps 306 and 316 increment i significantly and step 312 increments i above the preconfigured threshold, step 312 may increment i by a lesser magnitude due to the decision from step 320 (i.e., whether the driver side of the vehicle is closer to the road edge) may not be fully indicative of whether the vehicle is engaging in wrong way driving. For example, if the vehicle is traversing on a one lane, one way road or a road with no shoulder on the driver side, the driver side of the vehicle may be closer to the road edge than the passenger side.

Next, at 324, the wrong way driving detection program 150 determines whether backwards facing signage is present on the driver side of the vehicle. Similar to using a forward-facing camera to determine whether signage is facing the opposite direction to the vehicle's traversal path in step 316, the wrong way driving detection program 150 may utilize image recognition technology to determine whether a reverse-facing sign is present on the driver's side of the vehicle. Typically in the United States, signage is located on the passenger side of the roadway. Therefore, the presence of signage on the driver's side of the vehicle that are facing the opposite direction may be a strong indication that the vehicle is travelling opposite to the intended flow of traffic.

If the wrong way driving detection program 150 determines whether the backs of signs are on the driver side of the vehicle (step 324, “Yes” branch), then the wrong way driving decision process 300 may proceed to step 326 to determine whether there is an equivalently shaped sign on the passenger side of the vehicle. If the wrong way driving detection program 150 determines the backs of signs are not on the driver's side of the vehicle (step 324, “No” branch), then the wrong way driving decision process 300 may return to step 302 to determine whether lane markings are detected while the vehicle is in motion.

Then, at 326, the wrong way driving detection program 150 determines whether any equivalently shaped signage is present on the passenger side of the vehicle. Again using image recognition technology, the wrong way driving detection program 150 may identify the presence of an equivalently-shaped sign as that identified on the driver side of the vehicle in step 324. The wrong way driving detection program 150 may determine the presence of reverse facing signs on either side of the road is not, under certain circumstances, an indication of wrong way driving. For example, if the vehicle is exiting a highway down an exit ramp, the wrong way driving detection program 150 may identify two signs facing away from the vehicle's course. Typically, such signs are “Do Not Enter” signs intended to warn wrong way drivers not to enter the highway through the exit ramp. As such, the wrong way driving detection program 150 may not always utilize the detection of reverse facing signs on either side of the roadway as an indication of wrong way driving.

If the wrong way driving detection program 150 determines there is an equivalently shaped sign on the passenger side of the vehicle (step 326, “Yes” branch), then the wrong way driving decision process 300 may return to step 302 to determine whether lane markings are detected while the vehicle is in motion. If the wrong way driving detection program 150 determines there is no equivalently shaped sign on the passenger side of the vehicle (step 326, “No” branch), then the wrong way driving decision process 300 may continue to step 322 to increase i.

Next, at 328, the wrong way driving detection program 150 determines whether the value of i satisfies a threshold. After proceeding through the wrong way driving decision process 300, the wrong way driving detection program 150 may determine whether the value of i satisfies a preconfigured threshold value. As previously described, if i satisfies the preconfigured threshold, the wrong way driving detection program 150 may determine that the driver is engaging in wrong way driving and that a corrective action to reduce or eliminate any dangers caused by possible wrong way driving is needed.

In one or more embodiments, the risk assessment value may be reset after one or

more preconfigured trigger events including, but not limited to, the passage of a preconfigured period of time, one iteration through the wrong way driving decision process 300, or a negative determination to any decision step encountered in the wrong way driving decision process 300 (i.e., steps 302, 304, 308, 310, 316-320, and 324-328).

If the wrong way driving detection program 150 determines the value of i satisfies the preconfigured threshold (step 328, “Yes” branch), then the wrong way driving decision process 300 may proceed to step 330 to initiate a warning system to the user. If the wrong way driving detection program 150 determines the value of i does not satisfy the preconfigured threshold (step 328, “No” branch), then the wrong way driving decision process 300 may return to step 302 to whether lane markings are detected while the vehicle is in motion.

Then, at 330, the wrong way driving detection program 150 initiates a warning system to the user. Should the wrong way driving detection program 150 determine the preconfigured threshold has been satisfied, the wrong way driving detection program 150 may perform one or more corrective actions. As previously described, the corrective action may be any action that reduces or eliminates the danger presented by a wrong way driver including, but not limited to, a warning notification displayed on a heads-up display of the driver's vehicle, a warning notification displayed on a heads-up display of each vehicle withing a preconfigured distance of the driver's vehicle, an audio alert played through the speakers of the wrong way driving vehicle or other vehicles within a threshold distance of the wrong way driving vehicle, initiating an on-dashboard indicator unique to indicating the vehicle is traversing the roadway in the wrong direction, initiating in-cabin warning lights (e.g., illuminating the passenger cabin in red), initiating hazard, or four-way, flashing lights on the wrong way driving vehicle, a notification transmitted to one or more third-party agencies (e.g. police, firefighters, ambulance service, highway department, etc.), and automatic relinquishment of driving control to the wrong way driving detection program 150 to move the vehicle to a safe location (e.g., a shoulder of the road) and decelerate speed until the vehicle is stopped.

It may be appreciated that FIGS. 2, 3A, and 3B provide only an illustration of one implementation and do not imply any limitations with regard to how different embodiments may be implemented. Many modifications to the depicted environments may be made based on design and implementation requirements. For example, although the examples provided in FIG. 2, 3A, and 3B relate to cars, the wrong way driving detection program 150 may be utilized for any type of motorized or unmotorized method of transportation including, but not limited to, wheeled vehicles (e.g., trucks, motorcycles, bicycles, all-terrain vehicles, etc.), watercraft (e.g., boats, ships, etc.), aerial vehicles (e.g., airplanes, helicopters, etc.), living beings (e.g., pedestrians), or any combination thereof (e.g., amphibious vehicles).

Additionally, in one or more embodiments, the wrong way driving detection program 150 may utilize virtual reality or augmented reality systems when displaying the notification of wrong way traversal to the user. For example, if the wrong way driving detection program 150 is used by a bicyclist wearing an augmented reality headset, the wrong way driving detection program 150 may display notifications of wrong way pathway traversal to the user through a display screen of the augmented reality system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
monitoring indications of wrong way traversal along a traversal path through one or more on-board, Internet of Things (IOT) sensors;
determining whether wrong way traversal of the traversal path is occurring based on a risk assessment value satisfying a preconfigured threshold; and
in response to determining the risk assessment value satisfies the preconfigured threshold, performing a corrective action to ameliorate the wrong way traversal.

2. The method of claim 1, wherein the risk assessment value is incremented for each roadway indication of wrong way traversal identified in the monitoring.

3. The method of claim 2, further comprising:
in response to determining lane markings are detected while in motion and that the lane markings are a yellow line and/or double lines on a passenger side of a vehicle, incrementing the risk assessment value by a preconfigured significant amount.

4. The method of claim 2, further comprising:
in response detecting a prohibitive entry sign on each side of the traversal path, incrementing the risk assessment value to a value equal to the preconfigured threshold; and
in response to detecting a prohibitive entry sign on a single side of the traversal path, incrementing the risk assessment value by a preconfigured significant amount.

5. The method of claim 2, further comprising:
in response to determining a driver side of a vehicle is close to an edge of the traversal path, incrementing the risk assessment value by a preconfigured amount.

6. The method of claim 1, wherein the roadway indications are selected from a group consisting of roadway signage indicative of the vehicle's current course being in the wrong direction to the flow of traffic and painted roadway indicators located incorrectly on the roadway.

7. The method of claim 1, wherein a mode of transportation along the traversal path is selected from a group consisting of wheeled vehicles, aerial vehicles, and aquatic vehicles.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring indications of wrong way traversal along a traversal path through one or more on-board, Internet of Things (IOT) sensors;
determining whether wrong way traversal of the traversal path is occurring based on a risk assessment value satisfying a preconfigured threshold; and
in response to determining the risk assessment value satisfies the preconfigured threshold, performing a corrective action to ameliorate the wrong way traversal.

9. The computer system of claim 8, wherein the risk assessment value is incremented for each roadway indication of wrong way traversal identified in the monitoring.

10. The computer system of claim 9, further comprising:
in response to determining lane markings are detected while in motion and that the lane markings are a yellow line and/or double lines on a passenger side of a vehicle, incrementing the risk assessment value by a preconfigured significant amount.

11. The computer system of claim 9, further comprising:
in response detecting a prohibitive entry sign on each side of the traversal path, incrementing the risk assessment value to a value equal to the preconfigured threshold; and
in response to detecting a prohibitive entry sign on a single side of the traversal path, incrementing the risk assessment value by a preconfigured significant amount.

12. The computer system of claim 9, further comprising:
in response to determining a driver side of a vehicle is close to an edge of the traversal path, incrementing the risk assessment value by a preconfigured amount.

13. The computer system of claim 8, wherein the roadway indications are selected from a group consisting of roadway signage indicative of the vehicle's current course being in the wrong direction to the flow of traffic and painted roadway indicators located incorrectly on the roadway.

14. The computer system of claim 8, wherein a mode of transportation along the traversal path is selected from a group consisting of wheeled vehicles, aerial vehicles, and aquatic vehicles.

15. A computer program product, the computer program product comprising:
one or more computer-readable tangible storage medium and program instructions stored on at least one of the one or more tangible storage medium, the program instructions executable by a processor capable of performing a method, the method comprising:
monitoring indications of wrong way traversal along a traversal path through one or more on-board, Internet of Things (IOT) sensors;
determining whether wrong way traversal of the traversal path is occurring based on a risk assessment value satisfying a preconfigured threshold; and
in response to determining the risk assessment value satisfies the preconfigured threshold, performing a corrective action to ameliorate the wrong way traversal.

16. The computer program product of claim 15, wherein the risk assessment value is incremented for each roadway indication of wrong way traversal identified in the monitoring.

17. The computer program product of claim 16, wherein the method further comprises:
in response to determining lane markings are detected while in motion and that the lane markings are a yellow line and/or double lines on a passenger side of a vehicle, incrementing the risk assessment value by a preconfigured significant amount.

18. The computer program product of claim 16, wherein the method further comprises:
in response detecting a prohibitive entry sign on each side of the traversal path, incrementing the risk assessment value to a value equal to the preconfigured threshold; and
in response to detecting a prohibitive entry sign on a single side of the traversal path, incrementing the risk assessment value by a preconfigured significant amount.

19. The computer program product of claim 16, wherein the method further comprises
in response to determining a driver side of a vehicle is close to an edge of the traversal path, incrementing the risk assessment value by a preconfigured amount.

20. The computer program product of claim 15, wherein the roadway indications are selected from a group consisting of roadway signage indicative of the vehicle's current course being in the wrong direction to the flow of traffic and painted roadway indicators located incorrectly on the roadway.
